(19) United States
(12) Patent Application Publication
(10) Pub. No.: US 2006/0031128 A1
(43) Pub. Date: Feb. 9, 2006

(54) System and associated method of marketing customized articles of clothing

(76) Inventor: Rickey K. Lamitie, Laguna Niguel, CA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/197,354

(22) Filed: Aug. 5, 2005

Related U.S. Application Data
(60) Provisional application No. 60/599,984, filed on Aug. 9, 2004.

(51) Int. Cl. G06Q 30/00

(52) U.S. Cl. 705/26

(57) ABSTRACT

A method of marketing customized clothing to a user via a virtual storefront including accessing the virtual storefront via an electronic interface, providing a selection of a type of clothing article to be customized from the user via the virtual storefront, providing a selection of at least one feature of the clothing article from the user, receiving an audio/visual query to prompt the user for at least one body measurement, and providing from the user at least one body measurement in response to the query, whereby the at least one body measurement is converted to finished measurements for the clothing article.

### CROSS REFERENCE TO RELATED APPLICATIONS

This application claims the benefit of the earlier filing date of U.S. Provisional Application No. 60/599,984, filed Aug. 9, 2004, entitled “Measuring Solution,” the entirety of which is incorporated herein by reference.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND OF THE INVENTION

The present invention relates generally to methods and systems for marketing custom-fitting clothing and, more specifically, to methods and systems for accurately acquiring measurement data and reliably converting the measurement data into finished tailoring data usable for a plurality of purposes.

One of the goals of the retail industry has been to provide custom-fit, tailored, custom-tailored, or made-to-measure clothing (collectively referred to as customized clothing) on a large scale. The production of customized clothing traditionally involves physically measuring the dimensions of a customer's body and producing, through a series of fittings and additional measurements, clothing that is customized to fit to the customer's unique dimensions. Typically, such physical measurement is performed by a tailor at a retail location. However, with the advent of Internet shopping, a significant need has arisen in the retail industry to acquire accurate measurements directly from the customer in order to find the proper ready-to-wear item or to produce a garment tailored to the customer's body type.

An existing deficiency in the traditional customization process is that these accurate physical measurements must currently be taken by each provider of customized clothing.

A further limitation of the traditional customization process is the frequency of exchanges of clothing articles in cases where a customer is renting formal wear, such as tuxedos or gowns, for a specific occasion or event. Conventionally, a customer physically goes to a location, such as a store, and is measured by a third party, such as a store employee. Prior to the event, such as a wedding, birthday, or other formal event, the customer must visit the store again to ensure the proper fit of the formal wear in case the measurement process was inaccurate. Often, the formal wear does not fit appropriately. For example, the suit jacket may not sit well along the shoulders or the pant length may be too short.

To account for this problem, the rental shop typically needs to order an entirely new formal item, such as a jacket or pants, to be shipped in from a central warehouse, re-tailor it, and have the customer come back. This exchange process involves a substantial amount of time and can add as much as $1-2 of cost per formal wear rental. The costs are attributable to a) added shipping costs, b) labor to re-ship and re-tailor the item, and c) the duplicative inventory dedicated to servicing a single customer, e.g. an exchange requires dedicating two of the same formal wear item to one person, thereby necessitating excess inventory.

Many of the errors that cause tailored clothing to initially not fit and result in exchanges and customer dissatisfaction occur because of inaccurate measurements and/or the inaccurate conversion of actual measurements to finished measurements. Accordingly, there is need for a system for custom-fitting clothing that accurately acquires a subject's measurements and reliably converts them into finished measurements. There is also a need for a system to be able to indicate when the measurements provided by a user are inconsistent or out of the norm. Likewise, there is a need for a system and associated methodology to provide uniform guidance for taking accurate, reproducible measurements.

### SUMMARY OF THE INVENTION

One aspect of the invention provides a method of marketing customized clothing to a user via a virtual storefront. The method includes accessing the virtual storefront to an electronic interface. A selection of a type of clothing article to be customized and a selection of at least one feature of the clothing article are provided by the user via the virtual storefront. An audio/visual query to prompt the user for at least one body measurement is received. The user provides at least one body measurement in response to the query, whereby the at least one body measurement is converted to finished measurements for the clothing article.

Another aspect of the invention provides an apparatus for marketing a customized clothing article including an interface configured to receive a set of body measurements from a storage medium, and a communication device configured to deliver an offer to sell a customized clothing article to a user.

An additional aspect of the invention provides a method for marketing clothing including providing an avatar or virtual salesperson via a virtual storefront configured to advertise at least one retail store that sells the clothing, and charging a fee from the at least one retail store each time a consumer purchases the clothing after providing at least one body measurement with an identification card.

A further aspect of the invention provides a computer storage medium containing executable code that, when executed, causes a general purpose computer to control an apparatus using a processing method. The processing method includes receiving the virtual storefront to an electronic interface. A selection of a type of clothing article to be customized and a selection of at least one feature of the clothing article are provided by the user via the virtual storefront. An audio/visual query to prompt the user for at least one body measurement is received. The user provides at least one body measurement in response to the query, whereby the at least one body measurement is converted to finished measurements for the clothing article.

It is understood that both the foregoing general description of the invention and the following detailed description are exemplary, but are not restrictive, of the invention.

### BRIEF DESCRIPTION OF THE SEVERAL VIEWS OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a hardware block diagram of a system for custom-fitting clothing in accordance with an exemplary embodiment of the invention;

FIG. 2 is a software block diagram of a system for custom-fitting clothing in accordance with an exemplary embodiment of the invention;

FIG. 3 is a block diagram of an exemplary web access system of the system of FIG. 2;

FIG. 4 is an exemplary kiosk of the exemplary web system of FIG. 3;

FIG. 5 is a flow diagram depicting a conversion process for measurement data and the further use of finished data;

FIG. 6 is an exemplary screenshot of a graphical user interface (GUI) of the web system of FIG. 3 for acquiring the age of an end-user;

FIG. 7 is an exemplary screenshot of a GUI of the web system of FIG. 3 for acquiring the height of an end-user;

FIG. 8 is an exemplary screenshot of a GUI of the web system of FIG. 3 for acquiring the weight of an end-user;

FIG. 9 is an exemplary screenshot of a GUI of the web system of FIG. 3 for acquiring the shoe size of an end-user;

FIG. 10 is an exemplary screenshot of a GUI of the web system of FIG. 3 for acquiring the chest measurement of an end-user;

FIG. 11 is an exemplary screenshot of a GUI of the web system of FIG. 3 for acquiring an over arm measurement of an end-user;

FIG. 12 is an exemplary screenshot of a GUI of the web system of FIG. 3 depicting an exception message;

FIG. 13 is an exemplary screenshot of a GUI of the web system of FIG. 3 for acquiring the pant waist measurement of an end-user;

FIG. 14 is an exemplary screenshot of a GUI of the web system of FIG. 3 for acquiring the abdomen measurement of an end-user;

FIG. 15 is an exemplary screenshot of a GUI of the web system of FIG. 3 for acquiring the seat measurement of an end-user;

FIG. 16 is an exemplary screenshot of a GUI of the web system of FIG. 3 for acquiring the out seam to floor measurement of an end-user;

FIG. 17 is an exemplary screenshot of a GUI of the web system of FIG. 3 for acquiring the short out seam measurement of an end-user;

FIG. 18 is an exemplary screenshot of a GUI of the web system of FIG. 3 for acquiring the insert shirt sleeve to knuckle measurement of an end-user;

FIG. 19 is a block diagram of an exemplary marketing and affiliate system;

FIG. 20 is a flow diagram according to a first exemplary functional scenario of the marketing and affiliate system;

FIG. 21 is a flow diagram according to a second exemplary functional scenario of the marketing and affiliate system; and

FIG. 22 is a flow diagram according to a third exemplary functional scenario of the marketing and affiliate system.

### DETAILED DESCRIPTION OF THE INVENTION

The term “clothing article” is intended to be construed broadly to include items such as hats, pants, jeans, sweaters, skirts, dresses, shirts, blouses, vests, jackets, coats, suits, gowns, and tuxedos. This list is merely illustrative and not exhaustive, as further clothing articles will be known to those skilled in the art and are meant to be included within the scope of the invention. Further, certain terminology is for convenience only and is not limiting. For example, the term “click” as used herein refers to the usual manner of selecting and accessing textual; and/or graphical based computer information. The term does not limit the present invention to mouse based peripherals or similar interface devices, but is simply utilized as a shorthand term for describing computer functionality and processes.

The present invention provides an apparatus and associated method of providing a virtual storefront for marketing customized clothing to a customer. The virtual storefront may be configured for Internet access such as a web based interface, or may be a standalone system. The virtual storefront receives a selection of a type of clothing article to be customized from a customer, such as a selection of a shirt. A selection of at least one feature of the clothing article is also received from the user, such as a color of the clothing article and/or style. The virtual storefront then provides an audio/visual query to prompt the customer for at least one body measurement. The customer provides at least one body measurement to the virtual storefront in response to the query through an appropriate interface.

The at least one body measurement is converted to finished measurements for the clothing article. The finished measurements allow fabrication of a new clothing article or modification of an existing article, such that a customized clothing article can be provided to the user based on the finished measurements and the selections.

An avatar or virtual salesperson may be configured to cooperatively interact with users of the system to provide guidance and to advertise at least one retail store that sells the clothing, and charging a commission from the at least one retail store each time a consumer purchases the clothing through use of the system. Instead of or in addition to an avatar or virtual salesperson, a live or prerecorded video sequence may also be used to provide information to the users.

An exemplary interface is configured to receive a set of body measurements from a storage medium, such as a portable electronic device, a bar code, a radio frequency identification (RFID) tag, a near field device, or a device employing a wireless technology such as Bluetooth or Microsoft smart personal object technology (SPOT). Multiple sets of body measurements may be stored to allow a user to order customized clothing for multiple people.

I. System

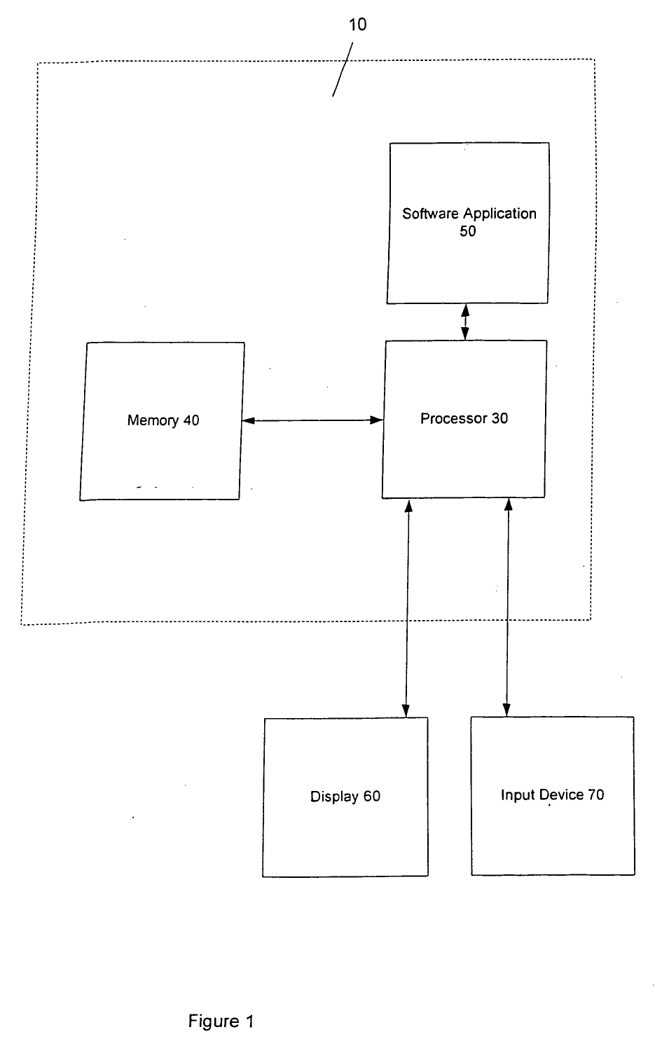

Referring now to the drawings, wherein like reference numerals designate like elements throughout the several views, an exemplary hardware block diagram of a system 10 for custom-fitting clothing is shown if FIG. 1. In an exemplary embodiment, system 10 includes executable code such as a software application 50 executed on a processor 30 of computer device 20, such as a personal computer (PC) or a personal digital assistant (PDA). Computer device 20 also includes memory 40 and interfaces to display 60 and input device 70. Input device 70, such as a keyboard, touch screen, or mouse, allows a user to input information in response to information provided by display 60.

For example, system 10 may be a personal computer including a microprocessor executing a Windows® based operating system and a software application providing the functions described herein. The description of standard PC features, such as local volatile and/or non-volatile memory, I/O capabilities, common peripheral devices, as well as hardware component functionality have been omitted for brevity, the detailed operation/description of which is well known to those skilled in the art.

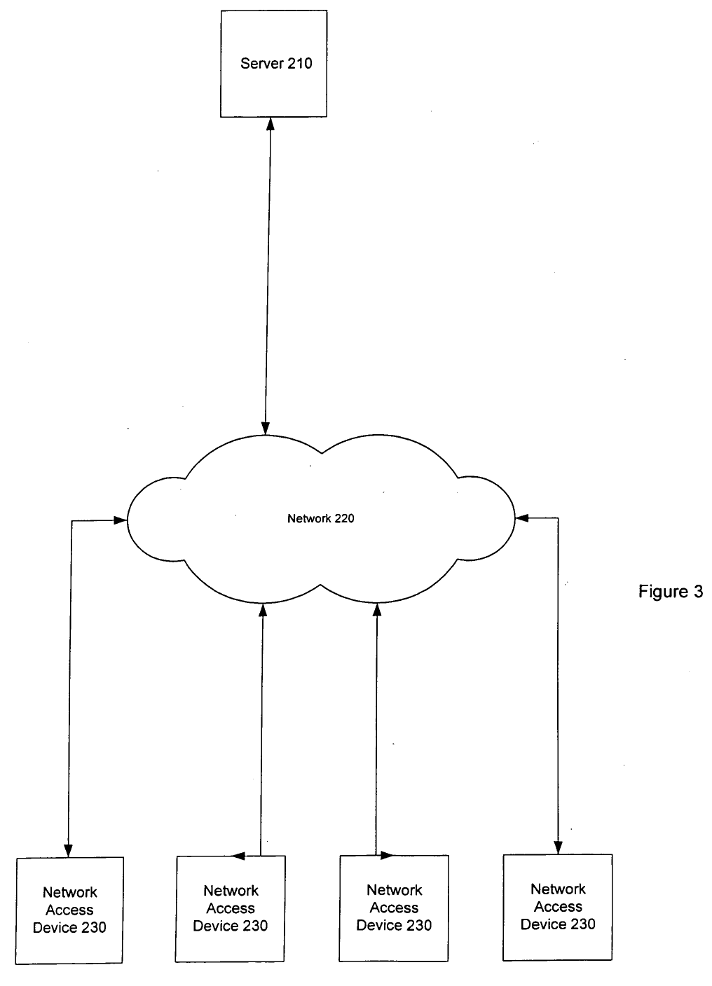

In another example, system 10 may include a software application running on a personal computer including the Microsoft® NT Server 4.x operating system as an interface to the Internet. In this embodiment, a graphical user interface (GUI) based operating system is described, however alternative operating systems may include but are not limited to Unix, Solaris, Linux, Windows 95, 98, 2000 and NT 4.0, as well as Apple MAC-OS (An example of a networked system is shown in FIG. 3.) Thus, a World Wide Web and file transfer protocol (FTP) front-end are included in system 10. Whether in push or pull configuration, the communication provided by system 10 may further exchange authentication data (i.e., user/appliance id, password) in accordance with an authentication protocol with the user 2. Those skilled in the art will recognize that a variety of authentication methods may be employed in the exemplary embodiment of the invention, including but not limited to Challenge Handshake Authentication Protocol (CHAP) only, CHAP and password Authentication Protocol (PAP), and PAP only.

Likewise, system 10 may also include executable code compatible with a Symbian® platform such as a cellular phone or PDA, or any other wired or wireless communication medium known in the art.) The user accesses a retailer's web site, which may offer a combination of standard products that may be custom fitted in accordance with the measurements provided by a user, or may offer exclusively custom made products. Thus, in an in-store environment, a user could either provide measurement information directly to an employee of the retailer who then enters the information into the system 10 including a software application on a computer, or use any self-service device such as a stand-alone kiosk, or use any computing device capable of accessing the Internet whether it resides within a retailer's store or remotely. Thus, the clothing custom-fitting system 10 enables a garment provider, such as an apparel retailer, to capture necessary information from a customer interested in sizing and custom fitting apparel, both remotely and in-store.

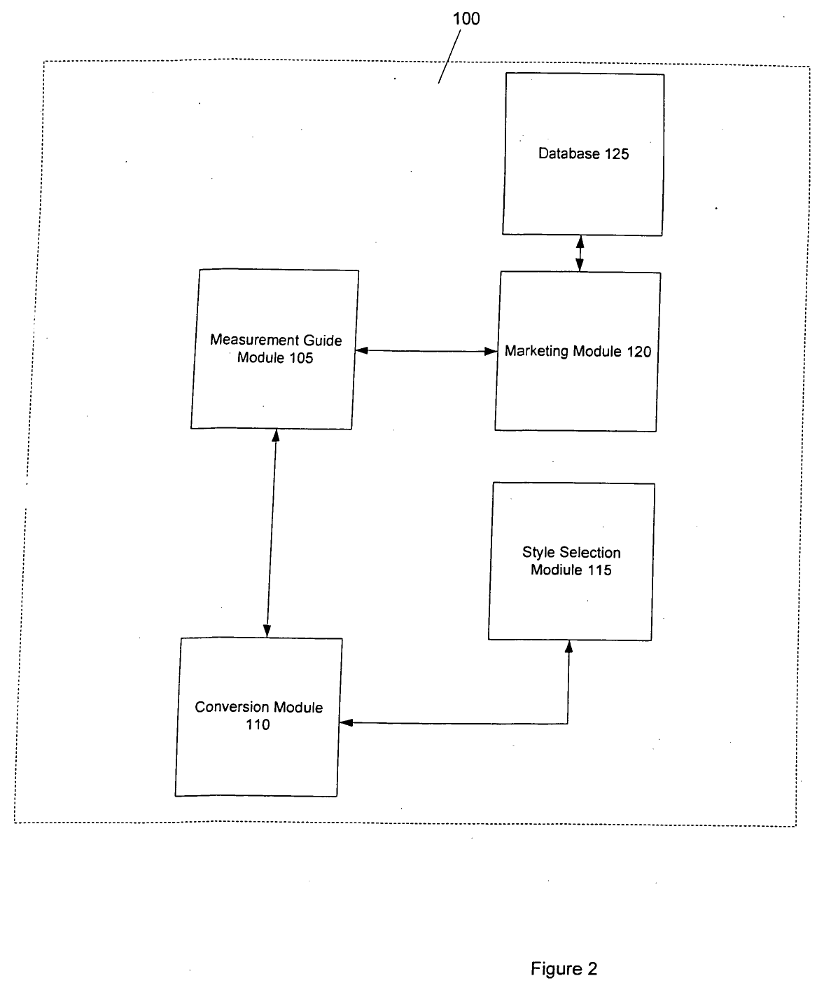

FIG. 2 is an exemplary software block diagram of an embodiment of the present invention. System 100 may include a measurement guide module 105, a conversion module 110, a style selection module 115, a marketing module 120, and a database 125.

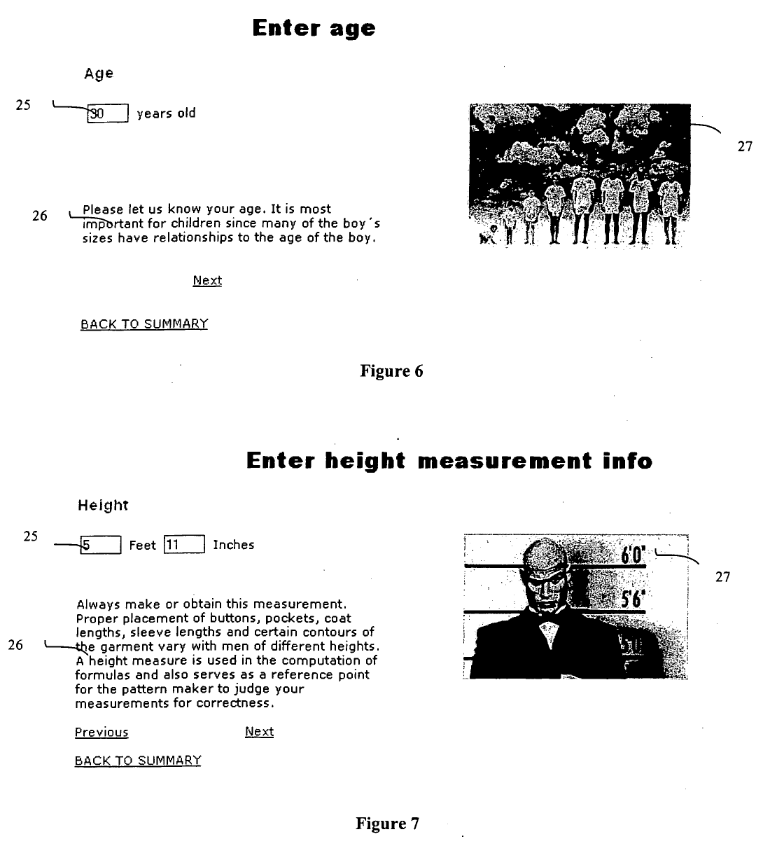

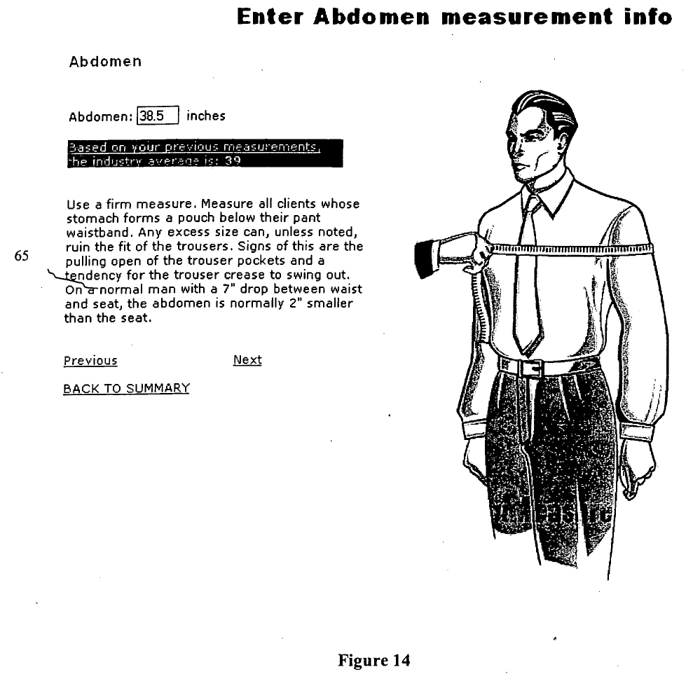

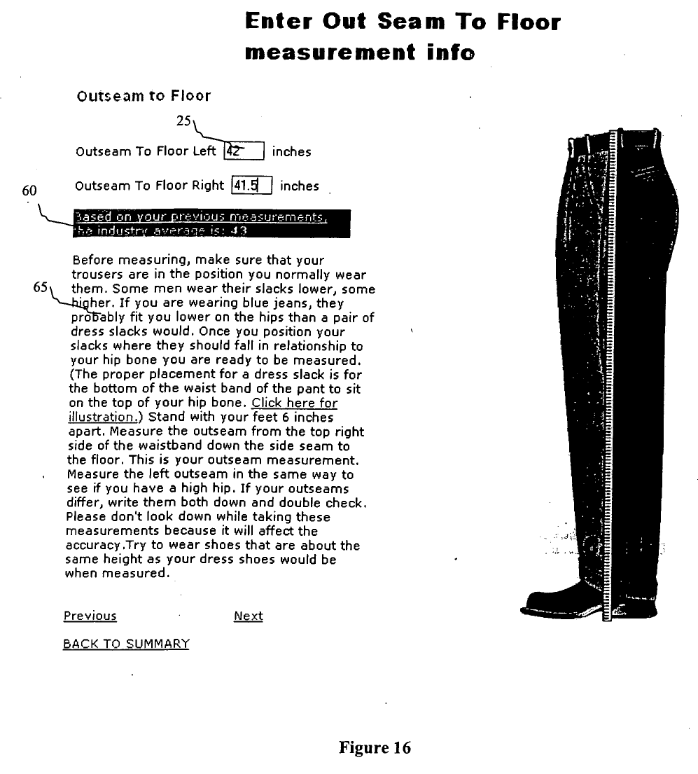

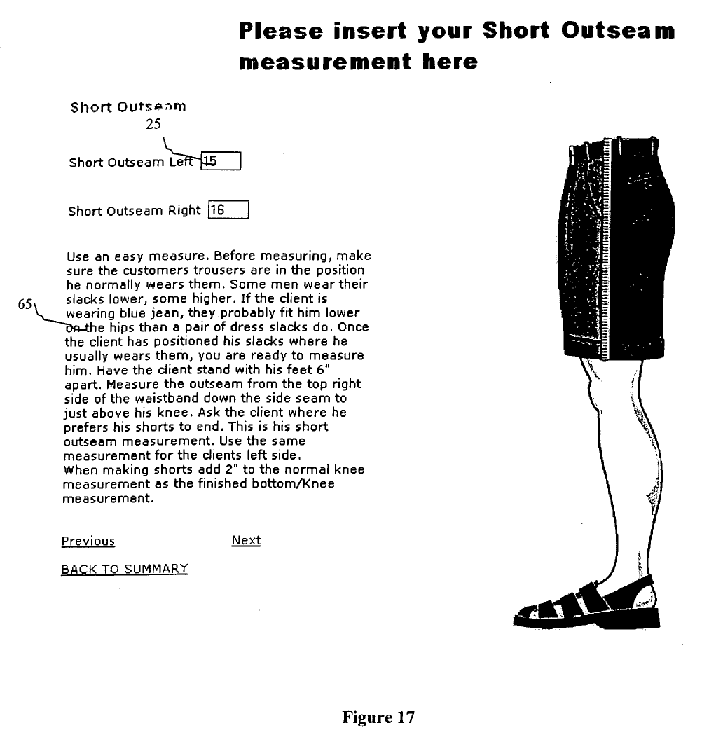

The measurement guide module 105 assists users, such as the customers who will wear the clothes (referred to herein as the end-user), tailors, persons purchasing the clothes as gifts, or other customers, capture data regarding the end-user's actual anatomical and/or physical measurements. In an exemplary embodiment, the measurement guide module 105 generates a plurality of GUIs that present a plurality of fields for receiving relevant measurement data specific to a subject, such as height, weight, waist, and/or shoe size. Of course, those skilled in the art will recognize that alternative measurements are within the scope of the invention. An exemplary set of GUIs is shown in FIGS. 6-18.

In an exemplary embodiment, measurement guide module 105 manages input from input device 70 and output to display 60. For example, measurement guide module 105 may manage input and output to measurement transducers, such as transducers configured to measure a subject's height and/or weight, and perform appropriate signal conditioning on the input signals.

The conversion module 110 utilizes actual measurements to generate finished measurements that are used to actually cut, sew, tailor, and customize clothing items. The conversion module 110 uses a plurality of conversion algorithms to derive the finished measurements. An exemplary set of conversion algorithms is provided in Appendix A.

An exemplary conversion module 110 is a software structure such as an xHTML or JAVA™ application for converting the raw body measurements to finished measurements for tailoring clothing. Of course, those reasonably skilled in the art will recognize that a hardware implementation residing on a server, or server side software such as a CGI script can also be provided to perform the above noted functions.

Exemplary style selection module 115 presents a graphical user interface that displays a plurality of categories and/or style options for the clothes that the user wishes to custom order and/or custom-fit. In the exemplary embodiment the style selection module 115 presents a plurality of product categories in which the user may be interested, such as pants, jeans, sweaters, skirts, dresses, shirts, blouses, vests, jackets, coats, suits, gowns, or any other product category evident to persons of ordinary skill in the art.

Once a product category is selected, the user is provided with a plurality of choices about the product they desire. For example, in the case of pants, the user may choose the fabric, color, style (such as tuxedo type, Italian style suit, double-breasted suit), whether they want cuffs or pleats, and the type of fly, such as zipper or button. Similarly, in the case of jackets, the user may choose the fabric, color, style, the number of buttons, and size of the lapel. Once the user has made all of the feature and style choices for the product, they provide the measurement information needed for sizing through the measurement guide 105, described above.

In an exemplary embodiment, marketing module 120 stores data input by users in database 125. Database 125 may be an internal or external database. Marketing module 120 uses the stored data to provide marketing opportunities to clothing retailers, as discussed in detail hereinafter.

FIG. 3 depicts an exemplary web access system 200 comprising a plurality of servers 210 communicating, via a network 220, with a plurality of client processor devices 230 such as general purpose computers, PDAs, kiosks, laptops, a web enabled phone, interactive television, or any other electronic medium used to access the Internet. In an exemplary embodiment, network 220 is the global communications network commonly referred to as the Internet. The network components communicate via network 220 through hypertext transfer protocol (HTTP) in this exemplary embodiment. Those skilled in the art recognize that while an exemplary embodiment is defined as being used with the Internet, the present invention is equally applicable to any local area network (LAN) or wide area network (WAN) configuration whether in land-based or wireless form. Similarly, the system described herein may be employed in a stand-alone configuration for access by multiple users. Examples of networks 220 useful with the invention include peer to peer networks, token ring networks, intranets, cellular networks, mesh networks, wireless networks, extranets, internets, local area networks, wide area networks, and other network arrangements as will occur to those of skill in the art. In an exemplary embodiment, the servers 210 host at least one website that, when accessed by a customer, provides a plurality of GUIs related to the measurement guide 105 of FIG. 2. Customers and/or end-users typically access the website using devices 230 to input a plurality of measurement data through the GUIs that are presented to the customer.

A website is a web based document communicatively linked between the server 210 and website using devices 230. In an exemplary embodiment, the GUIs described herein include known static HTTP based components, such as HTML, as well as dynamic components, including server side executable components such as JAVA™, Active-X, common gateway interface (CGI) scripts, and the like. Those skilled in the art recognize that a variety of protocols, programming structures, and interface options may be utilized for conveying web based information between a central location and a remote location, and that the present invention is not limited to the examples discussed herein.

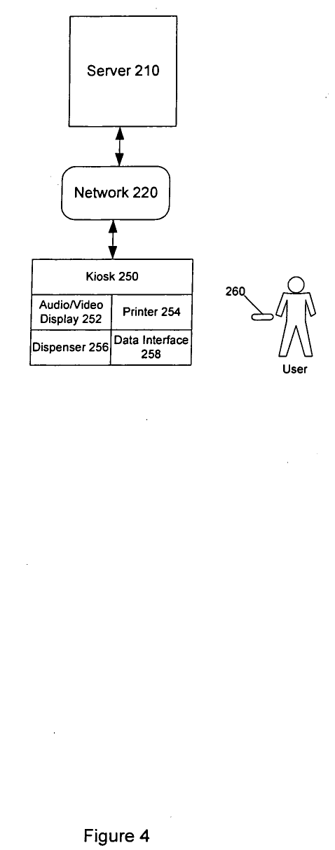

In an exemplary embodiment, device 230 is a kiosk including an interface configured to read information from a storage device. The kiosk may, for example, be located in a clothing retailer's store, in a mall containing one or more retailers selling clothing, or standing alone on a sidewalk. Exemplary kiosk 250 is shown in FIG. 4. Kiosk 250 includes an audio/visual display 252, a printer 254, a dispenser 256, and a data interface 258.

Printer 254 is configured to print, for example, a map to local stores selling a clothing article, or a coupon.

Dispenser 256 is configured to provide an intelligent device capable of storing measurements and providing marketing opportunities to vendors, for example, a keychain, card, or pen.

Data interface 258 is configured to receive data from storage device 260. Interface 258 may be an RFID interface, a bar code reader, or a magnetic stripe reader. Storage device 260 may be, for example, a keychain, a cell phone, or an identification card. The storage device may incorporate an RFID tag, a bar code, or a magnetic stripe to store a set of measurements for a user. The set of physical measurements stored on the storage device is then input into the kiosk through interface 258. Thus, a single set of physical measurements may be read and utilized by a plurality of retail locations and retailers. Further, a user may have a set of measurements for all of their family members stored on the storage device, allowing the user to order customized clothing for a family member as a gift, without the knowledge of the family member.

Kiosk 250 may also be configured to provide a storage device with sets of body measurements saved thereon. The storage device may be provided to the user via the dispenser 256. In this case, data interface 258 may also include a keyboard or the like to allow a user to input a set of measurements manually. In another embodiment, audio/visual display 252 includes a touch screen interface to allow users to input a set of body measurements.

II. Methodology

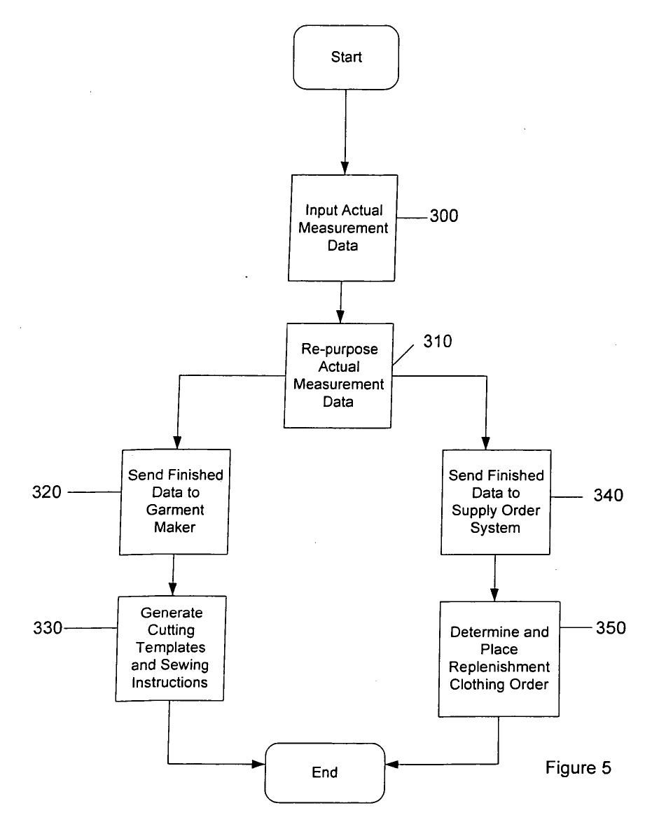

FIG. 5 is a flow diagram depicting exemplary processes of the present invention. Users input actual measurement data through a plurality of GUIs, such as those of FIGS. 6 through 18 (step 300). The actual measurement data is then re-purposed using a plurality of conversion algorithms, such as those of Appendix A, into finished data (step 310). In an exemplary embodiment, the finished data of step 310 are communicated to an automated garment pattern maker software system (step 320), over a network such as the Internet. The pattern maker generates fabric cutting templates and sewing instructions (step 330). In another embodiment, the finished data of step 310 are input into an Enterprise Information System (EI) such as a supply order system of a tuxedo rental facility (step 340). The supply order system determines lot sizes and dimensions of replenishment apparel and places orders based on the finished data (step 350).

In an exemplary embodiment, the data entered by users is stored in a database, such as an Oracle 8.x Database Management System. User entered data is passed to the database as Asynchronous Common Gateway Interface (ACGI) events from a commercial server application to the database management system. System 100 then retrieves the relevant data, formats it into the proper hypertext markup language (HTML) file, and streams the file directly for uploading to the GUIs.

In another embodiment, the data entered by users is converted to final measurement data by the HTML (xHTML) data entry page. The final measurement data and customer information is then sent by the HTML data entry page to the database to be stored. In addition, the same exemplary functionality can be provided by JAVA™ or like client side executables. Of course, those skilled in the art will recognize that the measurement conversion computation is equally applicable to server side execution.

FIGS. 6 through 18 provide screenshots of exemplary GUIs for inputting a plurality of measurements. For example, FIGS. 6 through 9 depict interfaces for inputting age, height, weight, and shoe measurements comprising appropriate text input boxes 25. Also advantageously displayed are support messages 26 that prompt the customer and/or end-user with encouraging comments on the respective measurement data that needs to be input. In an exemplary embodiment, the user experience with the GUIs is made more educational, interactive, or comprehensible by displaying images such as image 27 that meaningfully describes the measurement data and/or an aspect incidental to the data.

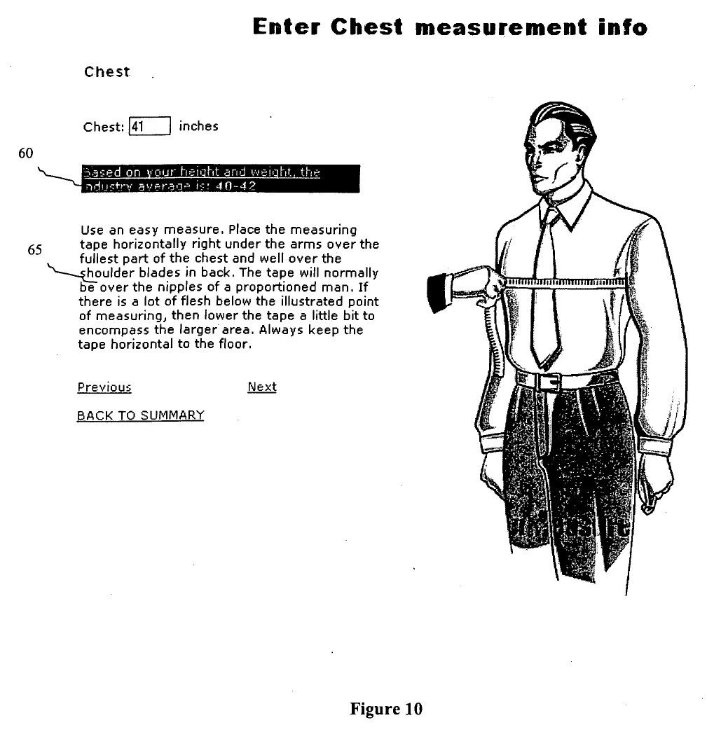

In an exemplary embodiment, the input screens also provide instructions and/or comments to the user on how to obtain accurate measurements. In an exemplary embodiment, instructions are conveyed to the user through one or a suitable combination of a plurality of textual, graphical and/or voice based messages. For example, if a particular input screen is being used by a user to input anatomical measurements such as those for pant length, seam length, the input screen would display textual message(s) in relation to each measurement that provides the user with instructions that aid the user in taking the measurements accurately. Thus, in each of the user interfaces of FIGS. 6 through 18, textual help instructions are provided to facilitate accurate measurement. Referring to a specific illustration in FIG. 10, a user is instructed to conduct a chest measurement and is provided a textual instruction 65 conveying the appropriate method for taking reliable chest measurements.

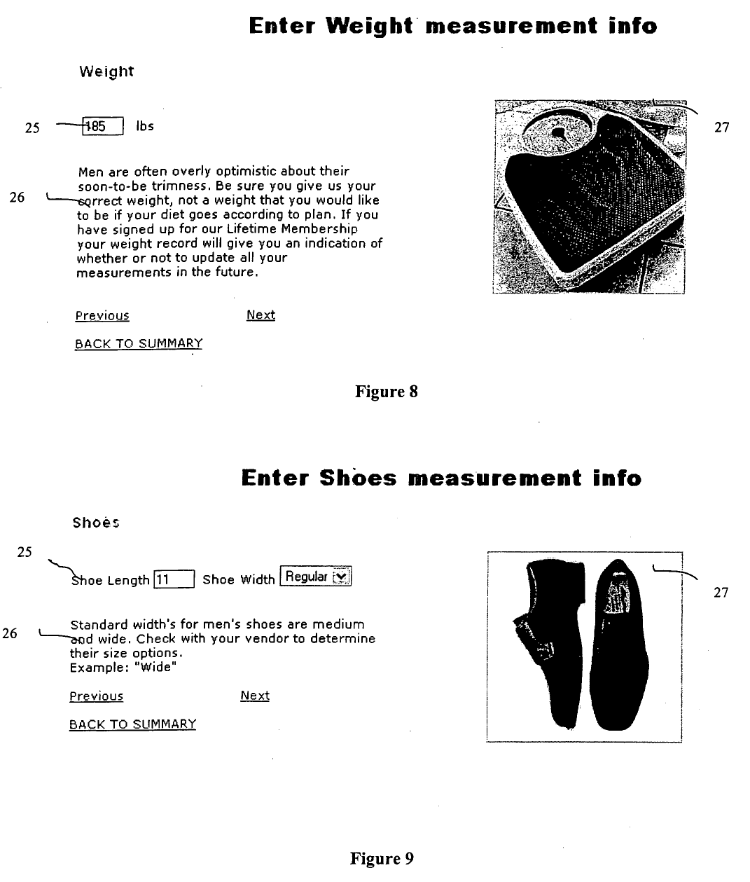

In an exemplary embodiment, these textual instructions are a series of benchmark process steps that the user must follow to take the specific measurements accurately. In another embodiment, the textual instructions include benchmarked industry tolerances for certain measurements. FIGS. 10-16 and 18 depict such industry average information based on other measurement data such as height, weight, or known standards. As a specific illustration, FIG. 10 shows a benchmark average message 60 which explains to the user that, based on height and weight data provided through inputs made in screens of FIGS. 7 and 8, the industry tolerance for a chest measurement is in a range of 40 to 42 inches.

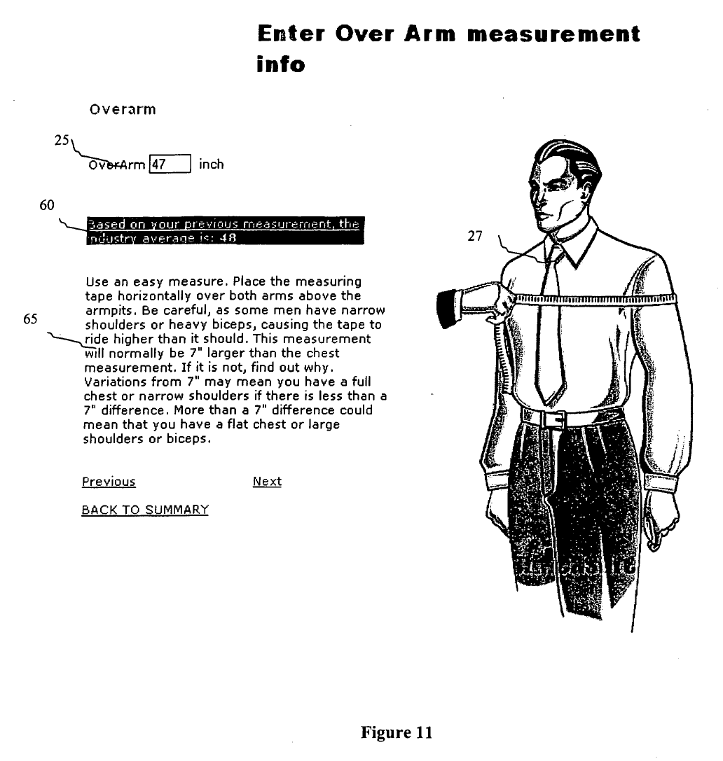

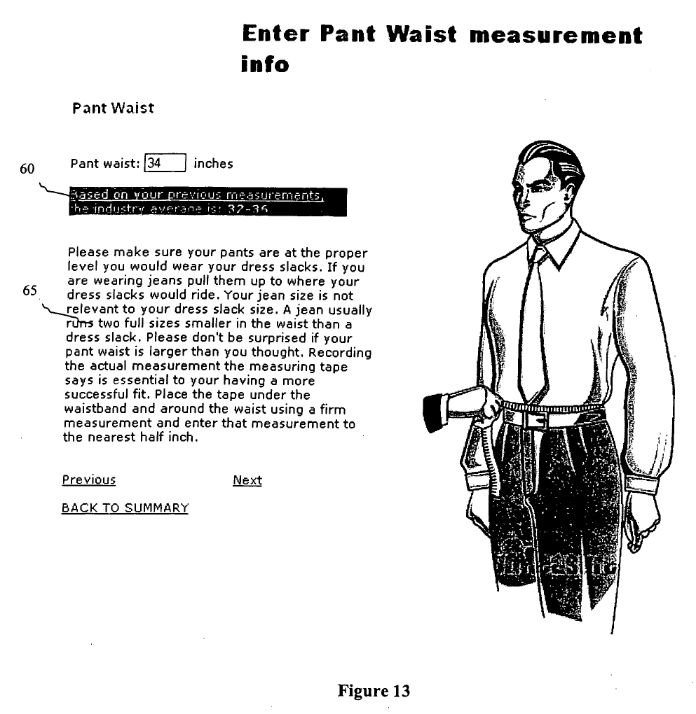

Similarly, FIG. 11 depicts industry average benchmark message 60 for over arm measurement on the basis of data proved by the user for chest measurement, height, and weight. FIG. 13 also conveys industry tolerance 60 for pant waist based on data provided by the user earlier. In an exemplary embodiment, the graphical representations also provide textual instructions such as comments 65 in FIG. 11 and comments 65 in FIG. 13. Such industry average information is calculated, in an exemplary embodiment, on the basis of empirical and/or logical relationships between different measurements, as further discussed below.

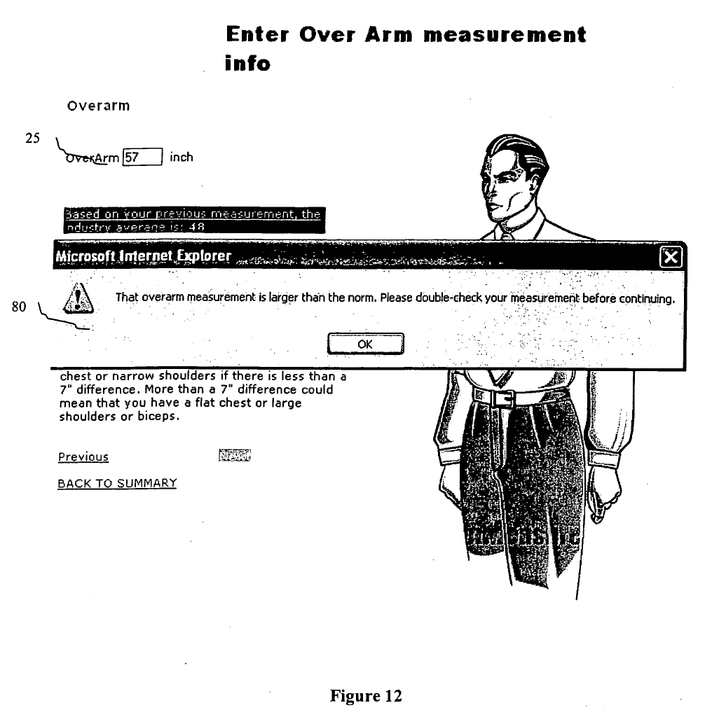

The measurements depicted and delineated in FIGS. 6-18 are representative of the type of measurements that can be obtained by the present system. One of ordinary skill in the art would appreciate that other measurements can also be obtained. Further, the measurements obtained by the present system may be obtained in the order presented in FIGS. 6-18 in order to facilitate the calculation of industry tolerances and subsequent use of the exception module and provision of exception screens 80, shown, for example, in FIG. 12 and further discussed below.

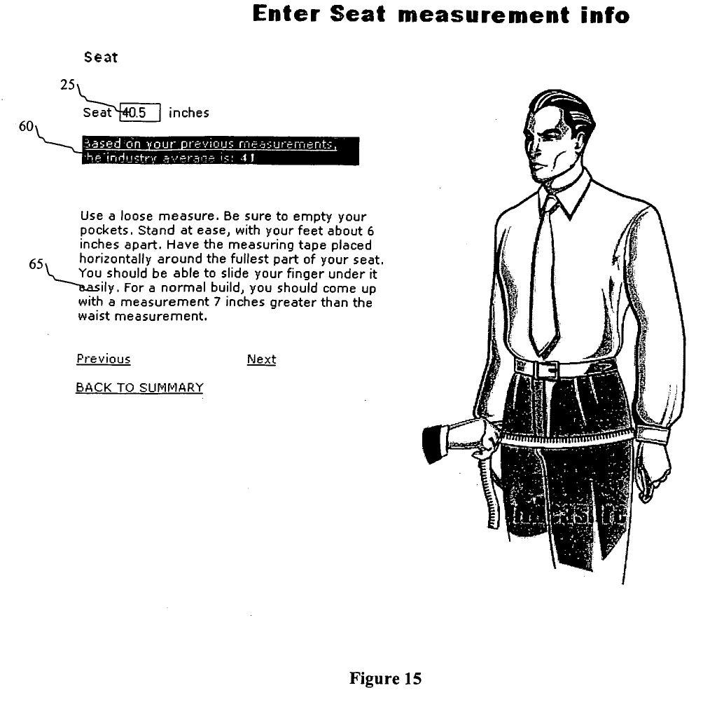

In another embodiment, the textual instructions are a set of descriptions of common mistakes that the user is warned against while taking the measurements. For example, FIG. 15 conveys instructions 65 that instruct the appropriate methodology of taking an abdomen measurement for a client whose stomach forms a pouch below his pant waistband.

In another embodiment, the textual instructions comprise historical measurements of the end user for the specific clothing parameter, such as waist size, shoe size, chest size, among other sizes, being requested. The system stores the end-user's historical measurements in a central database system, typically comprising a server and storage software, using identifying information, such as the end-user's name, password, account number, or other identifying information. Upon accessing the system, the user is prompted with the option of accessing the end-user's historical measurements. If the user approves, the user is further prompted to input identifying data, such as a name, password, or other indicia, of the end-user.

The system retrieves the historical measurements and presents the appropriate corresponding measurement at each measurement input screen. Therefore, at the appropriate screen, the user will be informed that, a year ago, for example, the end-user's waist size was 38 and shoe size was 10½. This historical perspective allows the user to check whether newly input measurements are accurate. For example, a tailor inputting a new set of measurements can compare the new measurements against the end-user's historical measurements. If certain measurements, which do not typically vary for an adult over time, are substantially different than the historical measurements, the tailor can re-measure the parameter, such as hat size or shoe size, to check the accuracy of the new measurement.

In another embodiment a graphical visual display is used to demonstrate what clothing parameter should be measured and how the measurement should be performed. In an exemplary embodiment, the display demonstrates, relative to a graphical representation of a human figure, accurate measurement techniques. The graphical representations instruct the end-user on the measurement methodology by visually presenting a tape measure positioned relative to the beginning point and end point that defines the measurement. Thus, the graphical representations instruct the user on how to accurately obtain a measurement of the seam length, chest, over arm, pant waist, shirt waist, abdomen, seat, thigh, out seam to floor, short out seam, pant leg front to floor, pant leg, rise, finished rise, finished bottom, finished knee, front vest, back vest, vest opening, yoke, shirt sleeve to knuckle, biceps, short sleeve, neck actual, shirt, coat, top coat, car coat, in-sleeve, pant leg back to floor, among other parameters.

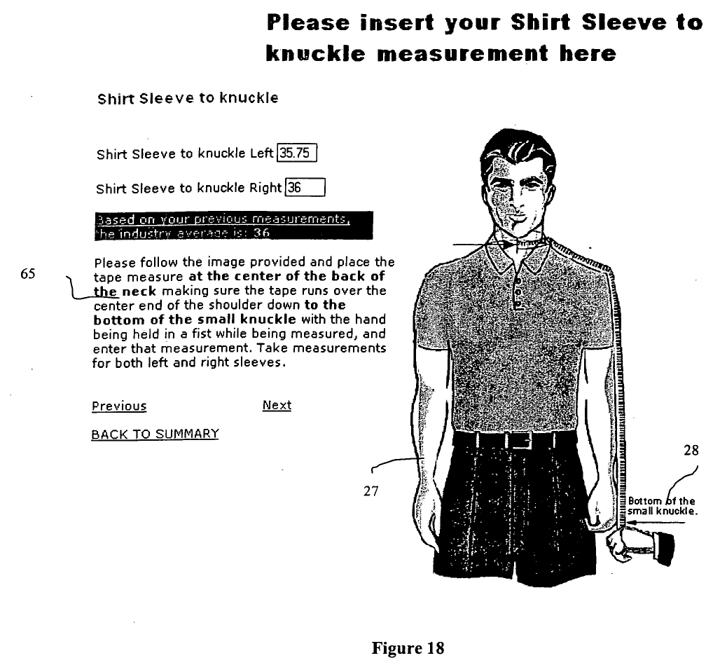

FIGS. 9 through 18 illustrate such graphical representations of a male relative to which accurate measurement techniques are depicted for various specific measurement parameters. For example, FIG. 18 provides a combination of textual 65 and visual 27 help for ‘shirt sleeve to knuckle measurement.’ Finer details, such as the specific place on the hand representing the measurement termination point 28, are also effectively emphasized in the graphical image 27. Video clippings demonstrating what needs to be measured and how it needs to be measured may also be displayed in alternate embodiments.

In another embodiment, voice instructions are provided to aid a user during measurements. Voice commentary/instructions are communicated in synchronization with a three-dimensional computer-generated avatar, such as a human capable of engaging in on-screen interactions, as discussed below.

Typical GUIs are often inferior to face-to-face communications in terms of succinctly conveying information. For example, a large amount of detailed information may be required to convey a single idea that in face-to-face scenarios could be conveyed in minutes. This occurs because GUIs usually do not provide the multiple communication channels used by humans, including speech, facial expressions, gestures and speech annotation. Therefore, in an exemplary embodiment, synthetic computer characters, such as two-dimensional animated graphical representations of humans (hereinafter referred to as avatars), are used to help remedy the disparity between the expressiveness of the GUIs and that of human presenters. Such characters are used by having the synthetic characters assume the metaphor of human-to-human conversation as a user interface mechanism. As discussed earlier, live or prerecorded video sequences may also be used to convey information to the user.

In an exemplary embodiment, an avatar is constructed using programs developed to interface with a JAVA™ run-time animation engine, such as Avatar Studio, a program that defines the visual look of the avatar and its range of motion, and Avatar Scripting Language, ASL, which defines the avatar's behavior. The avatar constructed using Avatar Studio includes a set of control points that can move over time on linear trajectories relative to the avatar's location. As known to persons of ordinary skill in the art, moving the control points animates the avatar. The Avatar Scripting Language (ASL) is a high-level scripting language that describes the avatars' behavior, including the commands that cause animation of the avatar. The ASL allows creation of a script that can be attached to an HTML document such as the GUIs of the measurement guide 105 of FIG. 2. The script is executed when designated text or image anchors in the GUI are activated. In an exemplary embodiment, the ASL files are ASCII text files. The ASL file includes a plurality of avatar script definitions. Each script definition defines a named behavior, which may include a set of sub-behavior commands. Commands exist, for example, for performing pre-defined poses, moving, scaling, i.e., changing size, and playing pre-recorded audio files. Thus, an avatar can “talk” using pre-recorded voice, can make facial expressions and gestures, and can pose. All these activities are performed synchronously to produce a narrative about an object and/or topic such as specific measurement data and/or an optimal measurement technique.

Standard expressions can be advantageously incorporated into an avatar that would ordinarily accompany face-to-face communications. For example, the avatar could include quizzical looks such as raised eyebrows or could register dissatisfaction by frowning when an end-user inputs measurement data that deviates from an industry-accepted tolerance. Thus, the combination of these facial expressions, body motions and an accompanying script can be used by the avatar to convey meaning in much the same way as would occur during face-to-face communications. The avatar is therefore enabled to communicate with the user to explain what to do in relation to specific measurements, prompt the user to be honest, and warn the user about the dangers of being inaccurate. The avatar adds a substantial psychological element to the system that prompts the user to be more honest and accurate than if he or she were simply responding to verbal questions or filling out a measurement card.

In an exemplary embodiment, the avatar prompts the user to input the intended wearer's eye color and skin tone, and the current season and temperature. The avatar may then suggest clothing articles for the user to consider purchasing.

In another embodiment, the avatar is configured to provide audio and/or video advertisements. The advertisements include information about local stores that sell the type of clothing selected by the user. If the user stores their measurements on an identification card, as discussed above, the system operator charges a commission from each of the stored advertised by the avatar where the user purchases an advertised product after providing their measurements with their identification card. The system operator could also provide a discount to each owner of an identification card, for example, by periodically providing a coupon.

Referring back to FIG. 2, the measurement guide 105 may further comprise an exception module that compares the user's input measurement information to a plurality of benchmark measurement information, such as industry average information, in order to determine whether a particular measurement is potentially inaccurate. Certain primary measurement parameters, such as height and weight, are indicative of a size range for other secondary parameters, such as waist size and pant leg. As measurements are input into the system, the system checks these secondary measurements to determine if they are accurate in light of previously entered primary measurements, such as height and weight. The exception module performs the accuracy check by comparing each secondary measurement to a range of measurements that, according to clothing industry averages for that measurement, would be likely based on certain primary measurements. Depending upon how the calculation is performed, any given measurement can function as either a primary or secondary measurement relative to other measurements.

For example, if a user inputs the end-user's height measurement as 6′2″ and weight measurement as 240 pounds and then inputs a waist measurement of 30″, the exception module would compare the 30″ waist measurement against the standard waist size range of a 6′2″, 240 pound individual to conclude that, taken together, the three measurements represent a physical body with dimensions that are out of the industry tolerance for these measurements. The exception module conveys an exception error to the user and prompts the user to recheck the various measurements, such as waist, height, and weight, to ensure none of the measurements are in error. Thus, the exception module provides analysis to make sure that a user does not input information that is likely erroneous.

FIG. 12 depicts an exception warning, generated by the exception module, for a measurement that is input through the measurement guide module graphical user interface. FIG. 12 conveys an exception warning for an over arm measurement. In FIG. 11, over arm measurement data 25 is received from the user and, concurrently, the system generates a display of an industry tolerance message 60 for this measurement, based, in an exemplary embodiment, on previously provided measurement data. Textual instruction 65 and graphical display 27 are also shown.

When the user inputs over arm measurement data, such as data 25 in FIG. 11, which deviates from the industry tolerance, an exception alert message 80 is raised. The exception module calculates exceptions, in an exemplary embodiment, using empirical and/or logical relationships between different measurements and known industry standards and/or averages. The approach compares and analyzes standard and industry average information on the basis of related measurement data to generate appropriate exceptions. To facilitate the comparison of measurements against industry average information, the present invention further comprises a database containing empirically derived industry average information and at least one processor for comparing measurements against the industry average information using algorithms. Exemplary algorithms that calculate standard and industry average information on the basis of related measurement data and generate exception screens are provided in Appendix A.

As stated above, system 100 optionally comprises marketing module 120 to either directly create offers for custom clothes to be emailed or direct-mailed to the user or provide data to an affiliate, such as another retailer who then, relying on data provided by the system 100, directly markets customized clothing to the user. In an exemplary embodiment, the marketing module functions as an interface that receives generic offers from third party retailers or other offering companies, customizes the offer to a plurality of end-users, and emails or direct-mails the offers to the end-users. In another embodiment, the marketing module functions as an interface that permits third party retailers or other offering companies to access end-user data, customize their own offers to a plurality of end-users, and email or direct-mail the offers to the end-users. In yet another embodiment, the marketing module packages customized clothing offers to end-users and, if accepted by the end-user, communicates the accepted offer to third party retailers or suppliers who then fulfill the accepted offer. In another embodiment, the marketing module functions as an interface that permits third party retailers to offer customized versions of clothing being requested on-line or in-stores by users. Each of the aforementioned modules, and the corresponding data flow, shall now be described in greater detail.

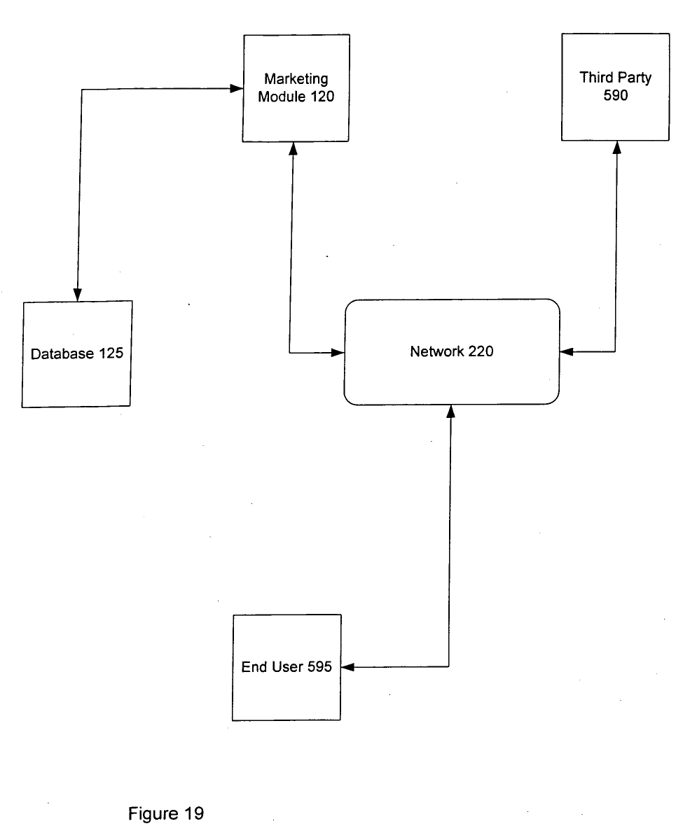

FIG. 19 shows marketing module 120 communicating with a plurality of third parties 590 such as retailers, tailors, marketing organizations and a plurality of end-users 595 through a network 220 such as the Internet or any other appropriate network system known in the art.

The marketing module 120 has access to a database 125 comprising a plurality of information with respect to a plurality of end-users. Such end-user information comprises data such as identification data of the end-user, for example, name, login/password, address, social security number; a plurality of current and historic measurement data for an end-user including the dates and times of submitting of the measurement data; and customized preferences of the end-user with respect to the plurality of measurement and style data with respect to a plurality of categories of clothes (as acquired from time to time through the measurement guide and style selection modules 105 and 115 respectively of FIG. 2). In an exemplary embodiment, the marketing module 120 is a software application running on at least one of a plurality of servers and accesses a database 125 such as an Oracle RDBMS that may run on the same server as the module 120 or on at least one of a plurality of database server clusters. Similarly, the third party systems 590 and end-user systems 595 are processing devices such as general purpose computers, servers, or any other processing devices running software such as an operating system, network access protocol stacks and any other software as would be readily evident to persons of ordinary skill in the art.

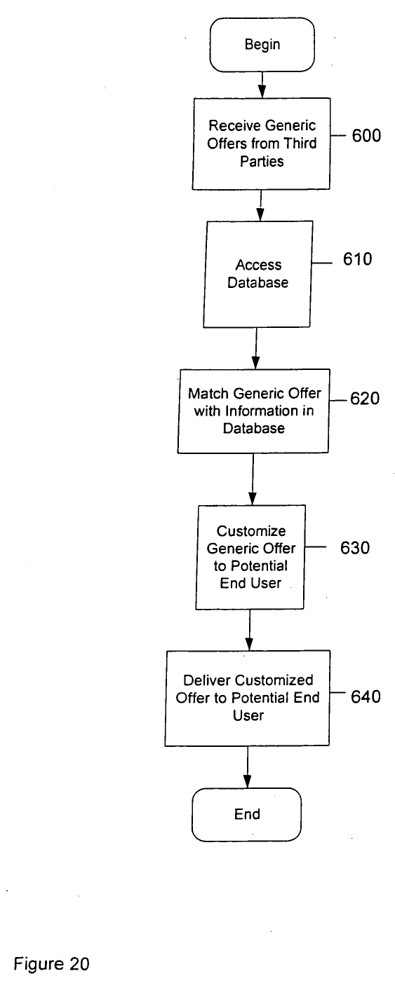

FIG. 20 shows a flow diagram according to a first exemplary functional scenario of the system illustrated in FIG. 19. The marketing module receives a plurality of generic offers from third parties (step 600). Such generic offers may comprise proposals for a plurality of garment categories and styles available in a plurality of generic measurements. For example, the offer may comprise polo style T-shirts available in five color schemes for three categories of measurements, such as small, medium and large. On receipt of such generic offers from third parties, the marketing module accesses the database comprising of end-user information (step 610). The marketing module matches the generic offer with the information available on the plurality of end-users from the database (step 620). For example, the database may provide data about end-users who have bought or custom ordered/tailored polo style T-shirts in the last 6 months. Such end-users are automatically flagged as potential buyer or interested end-users for the offer. Further, the marketing module maps the generic measurement categories of small, medium and large sizes with the measurement data stored in the database for the end-users to isolate samples of potential end-users who would fall in those generic size categories. Additionally, color preferences of the potential end-users are also matched with the exemplary five color schemes in the offer.

Thus, potential end-users are identified and segregated into appropriate categories using a plurality of end-user characteristic information (such as measurement data, style and category of clothes preferred, etc.) that are matched to a plurality of attributes of a generic offer (such as type of garment, color schemes and generic sizes). On the basis of the step 620, the generic offer is customized with respect to each potential buyer/end-user (step 630). The marketing module then communicates the offer to the potential end-users through any or all of the available modes of communication not limited to emails or direct-mails, telephonic customer contact programs, and snail mails (step 640).

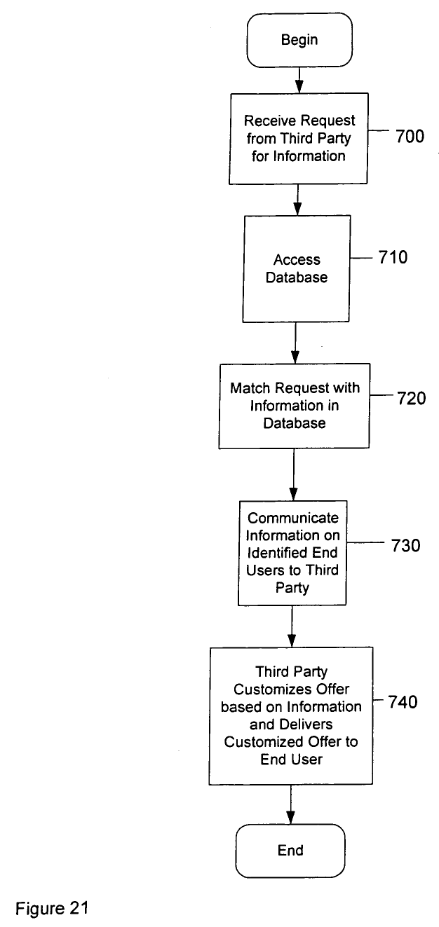

FIG. 21 depicts a flow diagram according to a second exemplary functional scenario of the system illustrated in FIG. 19. The marketing module receives requests from third parties for information on a plurality of end-users (step 700). For example, a retailer may request to know about females who have bought standard or custom-ordered blouses with a “V” or a “U”-shaped neck style in the last 3 months. Another retailer may want to know about females who have bought or custom-ordered blouses with a specific demand for a customized neck shape. Based on such request, the marketing module accesses the database (step 710). The marketing module matches the request attributes with the universe of end-user information to identify potential end-users (step 720). The marketing module then communicates information about the identified end-users to the third party retailer (step 730). The third party retailer on receipt of the potential end-user information from the marketing module customizes offers based on end-user characteristics and email or direct-mail the offers to the end-users (step 740).

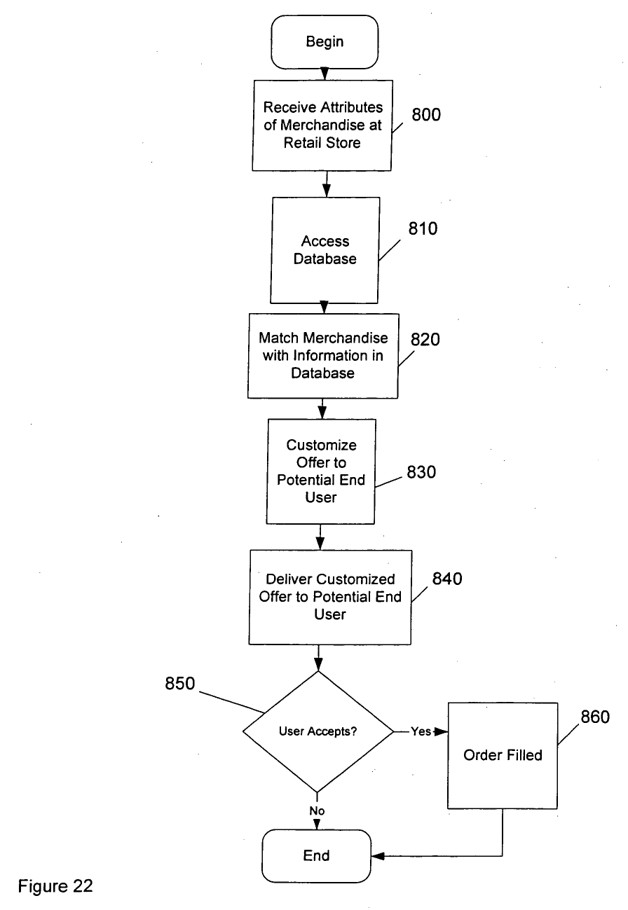

FIG. 22 depicts a flow diagram according to a third exemplary functional scenario of the system illustrated in FIG. 19 where the marketing module customizes offers for a plurality of end-users. This customization occurs as a trigger to the arrival of replenishment merchandise in a retail store. Thus, in an exemplary embodiment, the marketing module is integrated with an inventory management system or a warehouse management system that enables the marketing module to be aware of the presence of a plurality of merchandise and attributes thereof. The marketing module receives attributes of the merchandise previously present and/or recently arrived or arriving at a retail store (step 800). The marketing module accesses the end-user information database (step 810). The marketing module matches the merchandise attributes with the universe of end-user information to identify potential end-users (step 820). The marketing module then customizes (step 830) and communicates (step 840) customized offers to the end-users for acceptance.

As described earlier offers can be communicated to end-users using a plurality of communication modes such as email or direct mail, telephonic contacts, chat communication, or any other mode that is found suitable for communication. In an exemplary embodiment an end-user logs on to the retailers website using an authentication login/password, where he is presented with the customized offers. The end-user may accept the offer either directly on the website by pressing an accept button or may reject the offer by pressing a reject/not accepted button. In other embodiments the end-user may reply to the email or direct-mail received by him or through a voice conversation over a telephone. If the end-user accepts the offer in step 850, the marketing module communicates this acceptance response to a third party such as a distributor, catalog marketer, retailer or any other third entity willing to participate in an affiliate program. The third party then fulfills the order to the end-user (step 860).

Additionally, the system 100 can be used to more accurately design and provide clothing for mass consumers. The measurement and style data acquired from a plurality of users by a retailer over a sufficient length of time can be used to determine broad standard size categories that have a better likelihood of fitting a large sample of users. As known to those skilled in the art, standard garments such as trousers, shirts, suits, and pullovers are available with retailers in at least four standard size categories such as: small, medium, large, and extra large. Taking waist size as an exemplary measurement, it is known that the waist dimensions progressively vary for the aforementioned four standard size categories. Thus, waist measurement data acquired from a large number of users can be used to determine a standard waist size and can be correlated with a certain age group to determine a standard waist size for each size category such that users belonging to a certain age group have the highest probability of either closely fitting the garment or pose a minimal re-sizing requirement.

In an exemplary embodiment, the present invention comprises a database with sizing information generated from the input of size information from a plurality of users. The database can be queried based on any demographic or size parameters, including gender, age, weight, height, or other variables. The database outputs the demographic or size parameters that are correlated with the variable query. For example, it may output that the average waist size for males ages 25 to 35 in Chicago is 34 inches or the average neck size for males ages 50 to 65 in Los Angeles is 18 inches.

Similarly, style data acquired from a plurality of users may be used to assess their preferences for certain styles of garments. As a result style data may be used by retailers to assess a change in fashion trend and customize garment merchandise mix accordingly. Thus, if trousers are being customized for two front pleats by a large number of users, the retailers would know that this could indicate a fashion trend and capitalize on this information while ordering further trousers from suppliers.

Obviously, readily discernible modifications and variations of the present invention are possible in light of the above teachings. It is therefore to be understood that within the scope of the appended claims, the invention may be practiced otherwise than as specifically described herein. For example, while described in terms of both software and hardware components interactively cooperating, it is contemplated that the system described herein may be practiced entirely in software. The software may be embodied in a carrier such as magnetic or optical disk, or a radio frequency or audio frequency carrier wave.

Any processes descriptions or blocks in flow charts should be understood as representing modules, segments, portions of code which include one or more executable instructions for implementing specific logical functions or steps in the process, and alternate implementations are included within the scope of the exemplary embodiment of the present invention in which functions may be executed out of order from that shown or discussed, including substantially concurrently or in reverse order, depending upon the functionality involved, as would be understood by those skilled in the art.

Thus, the foregoing discussion discloses and describes merely exemplary embodiment of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

1. A method of marketing customized clothing to a user via a virtual storefront, comprising:
accessing the virtual storefront via an electronic interface;
providing a selection of a type of clothing article to be customized from the user via the virtual storefront;
providing a selection of at least one feature of the clothing article from the user;
receiving an audio/visual query to prompt the user for at least one body measurement; and
providing from the user at least one body measurement in response to the query, whereby the at least one body measurement is converted to finished measurements for the clothing article.

2. The method recited in claim 1, wherein providing a selection of a type of clothing article to be customized from a user via the virtual storefront includes providing a selection of a type of clothing article to be customized from a user via a computer network.

3. The method recited in claim 1, wherein providing a selection of a type of clothing article to be customized from a user via the virtual storefront includes providing a selection of a type of clothing article to be customized from a user via a wireless communication medium.

4. The method recited in claim 1, wherein providing a selection of a type of clothing article to be customized from a user via the virtual storefront includes providing a selection of a type of tuxedo.

5. The method recited in claim 1, wherein receiving an audio/visual query to prompt the user for at least one body measurement includes receiving an avatar prompting the user for at least one body measurement.

6. The method recited in claim 1, further comprising:
providing an order for a customized clothing article based on the finished measurements.

7. The method recited in claim 1, further comprising:
providing a plurality of body measurements, the plurality of body measurements being analyzed to determine if the measurements are within predetermined tolerances; and
receiving a warning via the virtual storefront if the plurality of body measurements is outside of the tolerances.

8. The method recited in claim 7, wherein receiving a warning via the virtual storefront if the plurality of body measurements is not within predetermined tolerances includes receiving a warning via the virtual storefront by way of an avatar of the virtual storefront.

9. The method recited in claim 7, wherein receiving a warning via the virtual storefront if the plurality of body measurements is not within predetermined tolerances includes receiving a warning via the virtual storefront by way of a video sequence.

10. The method recited in claim 1, further comprising:
providing a plurality of body measurements, the selections of the type of clothing article, and the at least one feature of the clothing article for storage in a marketing database.

11. The method recited in claim 10, further comprising:
receiving an offer to sell a clothing article based on the data stored in the marketing database.

12. The method recited in claim 11, wherein receiving an offer to sell a clothing article based on the data stored in the marketing database includes receiving an offer to sell a second clothing article based on an availability of the clothing article.

13. An apparatus for marketing a customized clothing article, comprising:
an interface configured to receive a set of body measurements from a storage medium; and
a communication device configured to deliver an offer to sell a customized clothing article to a user.

14. The apparatus recited in claim 13, further comprising:
a data store configured to store data including selections of a type of clothing article and at least one feature of the clothing article and the set of body measurements in a marketing database; and
a data transmission device configured to provide the marketing database to a plurality of clothing suppliers.

15. The apparatus recited in claim 13, further comprising:
a printer configured to provide a map of a shopping mall where the apparatus is located, the map including indicia identifying locations where the customized clothing article is available.

16. The apparatus recited in claim 13, further comprising:
a dispenser configured to provide a storage medium having at least one set of body measurements saved therein.

17. The apparatus recited in claim 13, further comprising:
an audio/visual display including a touch screen configured to receive input of a set of body measurements.

18. The apparatus recited in claim 13, further comprising:
a manual data interface configured to receive a set of body measurements manually input by a user.

19. The apparatus recited in claim 18, wherein the manual data interface is a keyboard.

20. The apparatus recited in claim 13, wherein the interface is configured to receive data of the set of body measurements via a barcode.

21. The apparatus recited in claim 13, wherein the interface is configured to receive data of the set of body measurements via an RFID tag.

22. The apparatus recited in claim 13, wherein the interface is configured to receive data of the set of body measurements via a barcode on a portable object.

23. The apparatus recited in claim 13, wherein the interface is configured to receive data of the set of body measurements via a keychain.

24. A computer storage medium containing executable code that, when executed, causes a general purpose computer to control an apparatus using a processing method, comprising:
accessing the virtual storefront via an electronic interface;
providing a selection of a type of clothing article to be customized from the user via the virtual storefront;
providing a selection of at least one feature of the clothing article from the user;
receiving an audio/visual query to prompt the user for at least one body measurement; and
providing from the user at least one body measurement in response to the query, whereby the at least one body measurement is converted to finished measurements for the clothing article.

25. A method of marketing customized clothing to a user via a virtual storefront, comprising:
receiving a selection of a type of clothing article to be customized from a user via the virtual storefront;
receiving a selection of at least one feature of the clothing article from the user;
providing an audio/visual query to prompt the user for at least one body measurement;
receiving from the user at least one body measurement in response to the query;
converting the at least one body measurement to finished measurements for the clothing article; and
receiving from the user an order for a customized clothing article based on the finished measurements and the selections.
